(19) United States
(12) Patent Application Publication
(10) Pub. No.: US 2019/0137058 A1
(43) Pub. Date: May 9, 2019

(54) PANEL LIGHT APPARATUS

(71) Applicant: XIAMEN ECO LIGHTING CO. LTD., XIAMEN (CN)

(72) Inventors: Xiaojun Ye, XIAMEN (CN); Huangbin Gan, XIAMEN (CN); Yi Lei, XIAMEN (CN)

(21) Appl. No.: 15/927,035

(22) Filed: Mar. 20, 2018

(30) Foreign Application Priority Data
Nov. 6, 2017 (CN) 201711080859.8

(51) Int. Cl. F21S 8/04; F21V 21/03; F21S 8/00

(52) U.S. Cl. CPC F21S 8/043; F21Y 2105/00; F21S 8/037; F21V 21/03

(57) ABSTRACT

A panel light apparatus is designed to be installed to a ceiling. The panel light apparatus has a bracket firstly fixed to the ceiling. The bracket has a first lateral side and a second lateral side. The panel light apparatus has a detachable panel module to be attached to the bracket. The detachable panel module has a panel, a surrounding wall, a back cover, a first connector and a second connector. When the detachable panel module is attached to the bracket, the first connector and the second connector respectively have insertion portions kept in holes of the first lateral side and the second lateral side of the bracket.

### FIELD OF INVENTION

The present invention relates to a panel light apparatus and more particularly related to a panel light apparatus to be fixed to a ceiling.

### BACKGROUND

With the new LED (Light Emitted Diode) technology, various traditional light devices now have more features, less weight, higher optical conversion rate, etc.

In the field of light devices, users usually want their light devices thinner, lighter while also easy and convenient to be installed to a desired position. For downlight devices, and panel light devices, they are usually fixed to a ceiling, which is usually very tall and cannot accessible without a ladder.

Therefore, it is inconvenient to install or to replace such light devices. Various structures are designed for better ways for doing such operation. Yet, when the light devices are thinner, everything becomes more difficult.

Thus, it is beneficial, if a reliable connecting structure that is easy to be installed while keeping a panel light device with a think thickness, it is beneficial to provide more convenient and effective light devices for human life.

### SUMMARY OF INVENTION

According to an embodiment of the present invention, a panel light apparatus is designed for being installed to a ceiling.

The panel light apparatus has a bracket, a LED module, a driver circuit, a panel, a surrounding wall, a back cover, a first connector and a second connector.

The bracket is firstly fixed to the ceiling, and other components are fixed to the bracket. The bracket has a first lateral side and a second lateral side. The first lateral side has a first hole, the second lateral side has a second hole.

The panel has an output opening. Light emitted from the LED module driven by a driving current of the driver circuit is output via the output opening to outside.

The surrounding wall is connected with the panel. The back cover is fixed to the surrounding wall. The first connector is fixed to a first side the surrounding wall. The second connector is fixed to a second side of the surrounding wall.

The panel, the surrounding wall, the back cover, the first connector and the second connector form a detachable panel module for being attached to the bracket.

When the detachable panel module is attached to the bracket, the first connector and the second connector respectively have insertion portions kept in the first hole and the second hole to fix the detachable panel module to the bracket.

In some embodiments, the panel light apparatus have more than two holes, instead of two. For example, the panel light apparatus may further include a third hole in the first lateral side and a fourth hole in the second lateral side of the bracket for connecting to a third connector and a fourth connector respectively fixed on the first side and the second side of the surrounding wall.

In some embodiments, the first connector and the second connector have rotation pins to be inserted into the first hole and the second hole by rotating the first connector and the second connector respectively. In such case, users firstly install and fix the bracket to a ceiling. The detachable panel module is then place below the bracket. After aligning the first hole and the second hole with the first connector and the second connector, users rotate the first connector and the second connector to rotate rotation pins into the first hole and the second holes respectively to fix the detachable panel module to the bracket.

In some other embodiments, only one of the first connector and the second connector has the rotation mechanism. For example, users firstly insert the first connector into the first hole of the bracket and then operate a rotation pin into the second hole of the bracket to fix the detachable panel to the bracket.

In some embodiments, the first connector has an elastic component for keeping the first connector in the first hole without an external force of a user, and for detaching the first connector away from the first hole when the user applies an external force against an elastic force of the elastic component.

For example, the rotation pin may be connected to a spring or an elastic clip. Users pull or push the rotation pin to leave its original position so as the rotation pin may be inserted into a corresponding hole of the bracket. When the rotation pin is inserted in the corresponding hole, the elastic component keeps the rotation pin to stay in the corresponding hole of the bracket.

In some embodiment, the elastic component is connected to an insertion pin disposed on a rotation shaft, the elastic component keeps the insertion pin in the first hole if no external force of a user is applied on the first connector. The insertion pin is rotated by the user against the elastic force of the elastic component to escape the insertion pin out of the first hole to detach the detachable panel module from the bracket.

In some embodiments, the second connector also has a similar elastic component, a similar insertion pin and a similar rotation shaft. In other words, both sides of the detachable panel modules have symmetric connector structures.

In some embodiments, a stop structure may be disposed in the first hole to keep the first connector to stay in the first hole unless an external force applied to lift the detachable panel module to detach the first connector out of the first hole. For example, a protruding block is disposed in the bottom side of the first hole of the bracket. Unless the detachable panel module is lifted for a certain height with respect to the protruding structure, the first connector is not capable of being detached from the first hole of the bracket. Such design enhances installation robustness of the panel light apparatus to meet an even better safety standard.

In some embodiments, the panel has a larger area than the bracket to cover the bracket.

In some embodiments, the bracket is a U shape structure. For example, there is a flat sheet as the bottom part of the letter ‘U’ and two lateral sides as the two lateral parts of the letter ‘U’. In addition, the first lateral side and the second lateral side of the bracket are at least partly overlapping with the surrounding wall of the detachable panel module. In other words, the detachable panel module may fit in the inner space between the two lateral sides of the bracket, which may significantly reduce the overall height of the panel light apparatus when it is installed to a ceiling. This is a critical design factor for panel light devices and brings great technical result.

In some embodiments, the bracket further includes a pluggable terminal for being electrically connected to the driver circuit. For example, when the bracket is fixed on a ceiling, an indoor electricity wire may be connected to the pluggable terminal of the bracket. In such case, when the detachable panel module is to be fixed to the bracket, the detachable panel module may have its electricity terminal to be plugged to the pluggable terminal of the bracket to significantly simplify installation work of the detachable panel module.

In some embodiments, the first connector is electrically connected to the driver circuit and an electrical terminal in the first hole of the bracket. In other words, the electricity connection structures may be disposed on the first connector and/or the second connector. In such case, when the detachable panel module is connected into the bracket, the electricity connection is done at the same time, because the first connector and/or the second connector is now plugged into a corresponding electricity terminal in the first hole and/or the second hole of the bracket.

In some embodiments, the back cover has a driver container space for storing the driver circuit inside the driver container space. In other words, part of complete driver circuit may be stored in the driver container space of the back cover, instead of providing an additional driver box to store the driver circuit. Such design may also decrease the overall size, as well as manufacturing cost of the panel light apparatus.

In some embodiments, the driver container space is defined by a convex part of the back cover. The back cover also has a concave part for pressing components below the back cover. For thin panel light apparatus, there may be some components like reflector sheet, lens or other components that need to be pressed to keep in desired locations. The back cover may have concave part facing downwardly to press these components. Meanwhile, the back cover may have some portion to be flat with respect to the concave part and such portion form a storing space for storing the driver circuit or other components.

In some embodiments, a connection wire between the LED module and the driver circuit is routed inside the detachable panel module.

In some embodiments, a height of the surrounding wall is less than 5 cm or 10 cm. In some embodiments, the panel is a polygonal shape. In some other embodiments, the panel is a circular shape.

In some embodiments, the LED modules are located on the surrounding wall and a light guide is used for guiding light of the LED module to the output opening.

In some embodiments, the back cover has a first aligning structure to fit to an associated a second aligning structure of the bracket for aligning the first connector to the first hole during installation.

### BRIEF DESCRIPTION OF DRAWINGS

FIG. 1 illustrates an example of a bracket and a detachable panel module.

FIG. 2 is a more specific example of a panel light embodiment.

FIG. 3 is another status of the embodiment of FIG. 2.

FIG. 4A is a component example of the embodiment.

FIG. 4B is another component example of the embodiment.

FIG. 4C is another component example of the embodiment.

FIG. 5 is an illustrative example of a panel light apparatus.

FIG. 6 illustrates several operation statuses of the example of FIG. 5.

FIG. 7A illustrates another embodiment.

FIG. 7B illustrates another status of FIG. 7A.

FIG. 8 illustrates component relation of an embodiment.

### DETAILED DESCRIPTION

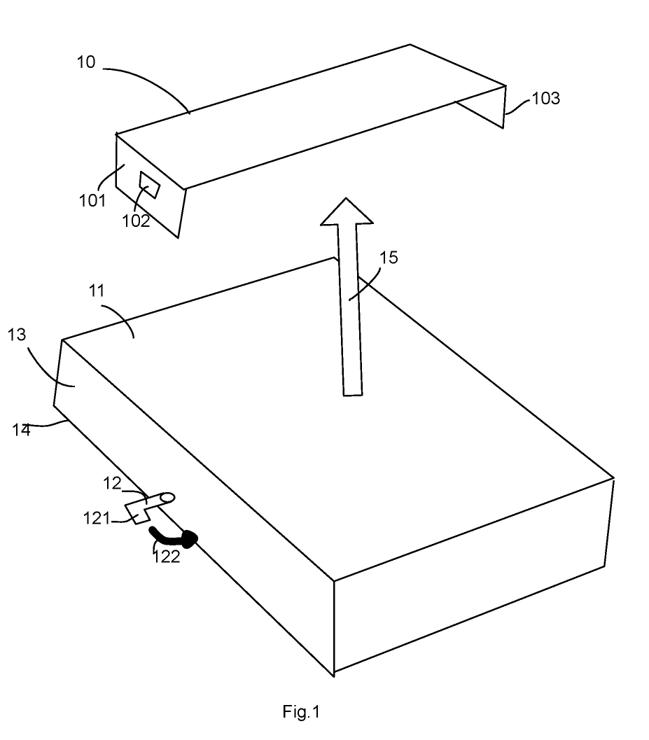

Please refer to FIG. 1. FIG. 1 illustrates an example of a bracket and a detachable panel module.

In FIG. 1, a bracket 10 has a first lateral side 101 and a second lateral side 103. In FIG. 1, it is illustrated that there is a first hole 102 in the first lateral side 101.

A detachable panel module has a back cover 11, a surrounding wall 13 and a panel 14. In addition, the detachable panel module has two connectors in the surrounding wall 13, like the first connector 12 illustrated in FIG. 1.

The detachable panel module is fixed along the direction 15 to the bracket 10. The first connector 12 has a rotation pin 121 to rotate with the rotation direction 122 to fit into the first hole 102 of the first lateral side 101 of the bracket 10 to attach the detachable panel module to the bracket 10.

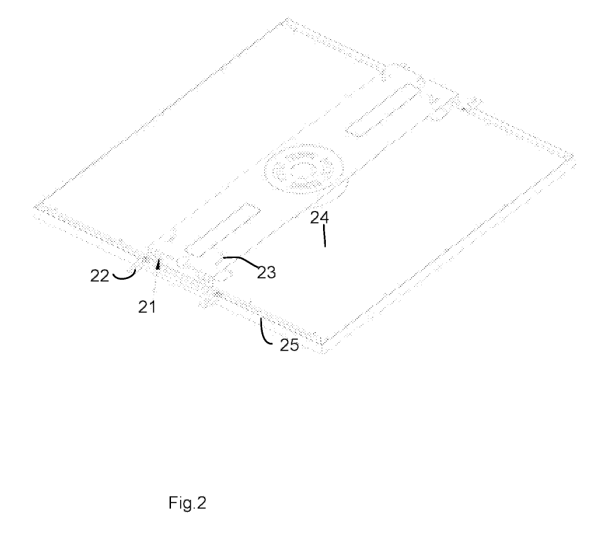

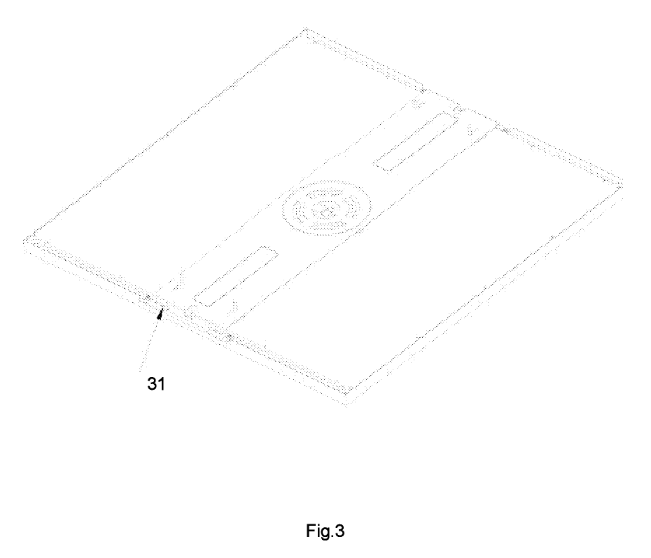

Please refer to FIG. 2 and FIG. 3. FIG. 2 is a more specific example of a panel light embodiment. FIG. 3 is another status of the embodiment of FIG. 2.

In FIG. 2 and FIG. 3, the bracket has a aligning structure, a hole to correspond a aligning structure 23 of a detachable module 24. A connector 22 is disposed on a side of a surrounding wall 25 to correspond to a hole 21 of the bracket.

In FIG. 3, it is illustrated that the connector is connected to the hole to form a fixing structure 31 between the bracket and the detachable panel module.

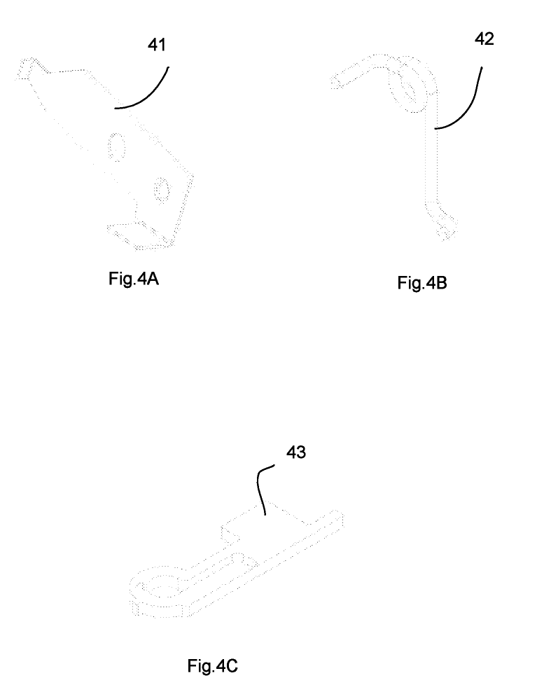

Please refer to FIG. 4A, FIG. 4B and FIG. 4C. FIG. 4A illustrates a component 41 example of the embodiment. FIG. 4B illustrates a spring component 42 example of the embodiment for providing elastic force. FIG. 4C illustrates a connector with a rotation pin 43.

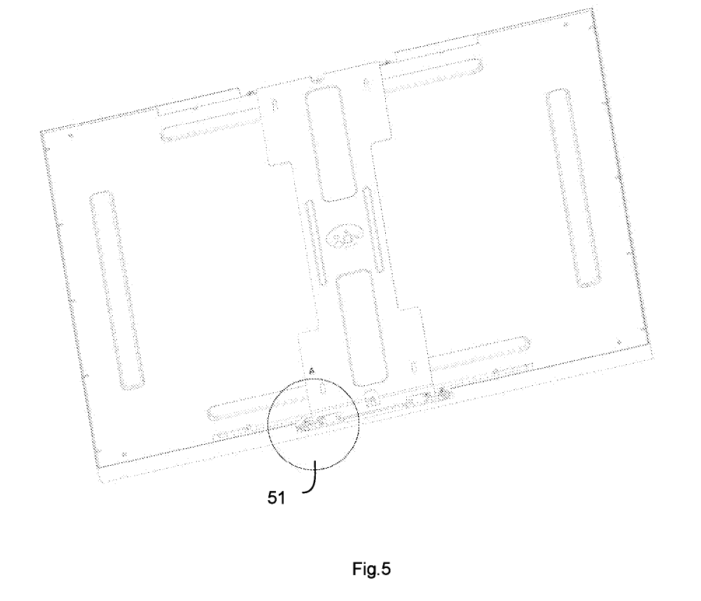

Please refer to FIG. 5. FIG. 5 is an illustrative example of a panel light apparatus. In the place marked with 51, a connection structure is provided.

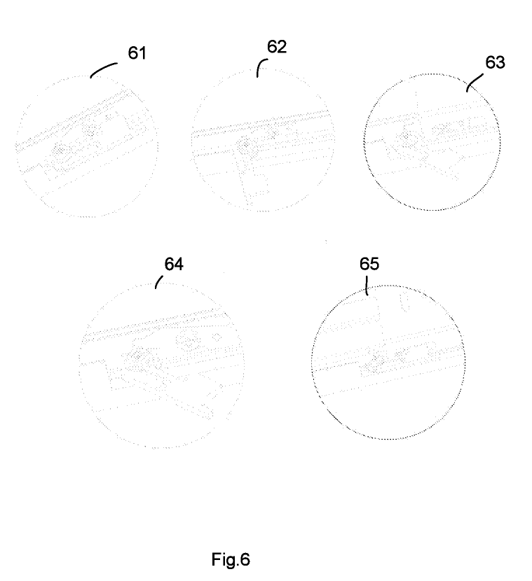

Please refer to FIG. 6. FIG. 6 illustrates several operation statuses of the example of FIG. 5. The enlarged portion illustrates several operation statuses 61, 62, 63, 64 and 65 of locking and removing connection between a bracket and a detachable panel module.

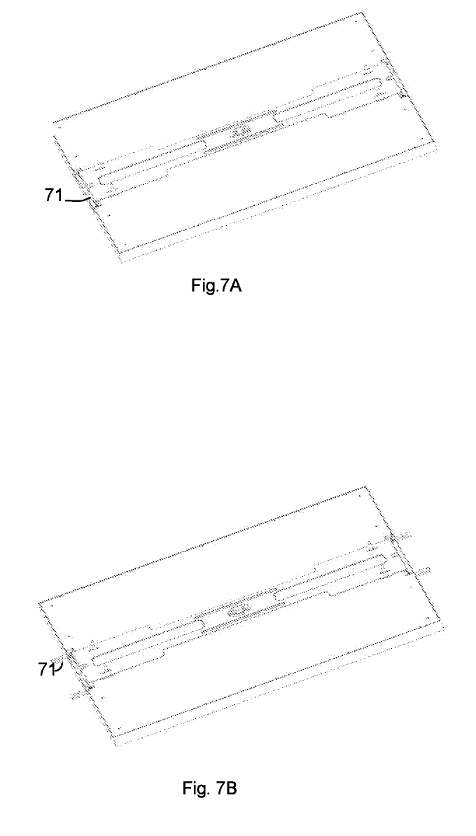

FIG. 7A and FIG. 7B illustrates another embodiment. In FIG. 7A and FIG. 7B, the bracket 71 has a different connection structure 71.

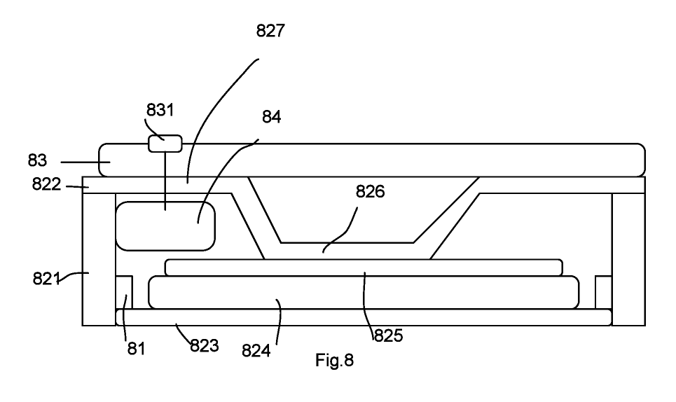

FIG. 8 illustrates component relation of an embodiment.

In FIG. 8, a back cover 822 has a convex part 826 for pressing a reflector 825. The back cover 822 has a concave part 827 for providing a storing space for storing a driver circuit 84. A LED module 81 is disposed at internal side of a surrounding wall 821. A light guide 824 is used for guiding light to an output opening 823 of a panel. The bracket 83 has a pluggable terminal 831 to be connected to the driver circuit 84 to conveniently install the panel module to the bracket 83.

According to an embodiment of the present invention, a panel light apparatus is designed for being installed to a ceiling.

The panel light apparatus has a bracket, a LED module, a driver circuit, a panel, a surrounding wall, a back cover, a first connector and a second connector.

The bracket is firstly fixed to the ceiling, and other components are fixed to the bracket. The bracket has a first lateral side and a second lateral side. The first lateral side has a first hole, the second lateral side has a second hole.

The panel has an output opening. Light emitted from the LED module driven by a driving current of the driver circuit is output via the output opening to outside.

The surrounding wall is connected with the panel. The back cover is fixed to the surrounding wall. The first connector is fixed to a first side the surrounding wall. The second connector is fixed to a second side of the surrounding wall.

The panel, the surrounding wall, the back cover, the first connector and the second connector form a detachable panel module for being attached to the bracket.

When the detachable panel module is attached to the bracket, the first connector and the second connector respectively have insertion portions kept in the first hole and the second hole to fix the detachable panel module to the bracket.

In some embodiments, the panel light apparatus have more than two holes, instead of two. For example, the panel light apparatus may further include a third hole in the first lateral side and a fourth hole in the second lateral side of the bracket for connecting to a third connector and a fourth connector respectively fixed on the first side and the second side of the surrounding wall.

In some embodiments, the first connector and the second connector have rotation pins to be inserted into the first hole and the second hole by rotating the first connector and the second connector respectively. In such case, users firstly install and fix the bracket to a ceiling. The detachable panel module is then place below the bracket. After aligning the first hole and the second hole with the first connector and the second connector, users rotate the first connector and the second connector to rotate rotation pins into the first hole and the second holes respectively to fix the detachable panel module to the bracket.

In some other embodiments, only one of the first connector and the second connector has the rotation mechanism. For example, users firstly insert the first connector into the first hole of the bracket and then operate a rotation pin into the second hole of the bracket to fix the detachable panel to the bracket.

In some embodiments, the first connector has an elastic component for keeping the first connector in the first hole without an external force of a user, and for detaching the first connector away from the first hole when the user applies an external force against an elastic force of the elastic component.

For example, the rotation pin may be connected to a spring or an elastic clip. Users pull or push the rotation pin to leave its original position so as the rotation pin may be inserted into a corresponding hole of the bracket. When the rotation pin is inserted in the corresponding hole, the elastic component keeps the rotation pin to stay in the corresponding hole of the bracket.

In some embodiment, the elastic component is connected to an insertion pin disposed on a rotation shaft, the elastic component keeps the insertion pin in the first hole if no external force of a user is applied on the first connector. The insertion pin is rotated by the user against the elastic force of the elastic component to escape the insertion pin out of the first hole to detach the detachable panel module from the bracket.

In some embodiments, the second connector also has a similar elastic component, a similar insertion pin and a similar rotation shaft. In other words, both sides of the detachable panel modules have symmetric connector structures.

In some embodiments, a stop structure may be disposed in the first hole to keep the first connector to stay in the first hole unless an external force applied to lift the detachable panel module to detach the first connector out of the first hole. For example, a protruding block is disposed in the bottom side of the first hole of the bracket. Unless the detachable panel module is lifted for a certain height with respect to the protruding structure, the first connector is not capable of being detached from the first hole of the bracket. Such design enhances installation robustness of the panel light apparatus to meet an even better safety standard.

In some embodiments, the panel has a larger area than the bracket to cover the bracket.

In some embodiments, the bracket is a U shape structure. For example, there is a flat sheet as the bottom part of the letter ‘U’ and two lateral sides as the two lateral parts of the letter ‘U’. In addition, the first lateral side and the second lateral side of the bracket are at least partly overlapping with the surrounding wall of the detachable panel module. In other words, the detachable panel module may fit in the inner space between the two lateral sides of the bracket, which may significantly reduce the overall height of the panel light apparatus when it is installed to a ceiling. This is a critical design factor for panel light devices and brings great technical result.

In some embodiments, the bracket further includes a pluggable terminal for being electrically connected to the driver circuit. For example, when the bracket is fixed on a ceiling, an indoor electricity wire may be connected to the pluggable terminal of the bracket. In such case, when the detachable panel module is to be fixed to the bracket, the detachable panel module may have its electricity terminal to be plugged to the pluggable terminal of the bracket to significantly simplify installation work of the detachable panel module.

In some embodiments, the first connector is electrically connected to the driver circuit and an electrical terminal in the first hole of the bracket. In other words, the electricity connection structures may be disposed on the first connector and/or the second connector. In such case, when the detachable panel module is connected into the bracket, the electricity connection is done at the same time, because the first connector and/or the second connector is now plugged into a corresponding electricity terminal in the first hole and/or the second hole of the bracket.

In some embodiments, the back cover has a driver container space for storing the driver circuit inside the driver container space. In other words, part of complete driver circuit may be stored in the driver container space of the back cover, instead of providing an additional driver box to store the driver circuit. Such design may also decrease the overall size, as well as manufacturing cost of the panel light apparatus.

In some embodiments, the driver container space is defined by a convex part of the back cover. The back cover also has a concave part for pressing components below the back cover. For thin panel light apparatus, there may be some components like reflector sheet, lens or other components that need to be pressed to keep in desired locations. The back cover may have concave part facing downwardly to press these components. Meanwhile, the back cover may have some portion to be flat with respect to the concave part and such portion form a storing space for storing the driver circuit or other components.

In some embodiments, a connection wire between the LED module and the driver circuit is routed inside the detachable panel module.

In some embodiments, a height of the surrounding wall is less than 5 cm or 10 cm. In some embodiments, the panel is a polygonal shape. In some other embodiments, the panel is a circular shape.

In some embodiments, the LED modules are located on the surrounding wall and a light guide is used for guiding light of the LED module to the output opening.

In some embodiments, the back cover has a first aligning structure to fit to an associated a second aligning structure of the bracket for aligning the first connector to the first hole during installation.

While the principles of this invention have been described in connection with specific embodiments, it should be understood clearly that these descriptions are made only by way of example and are not intended to limit the scope of the invention.

1. A panel light apparatus for being installed to a ceiling, comprising:
a bracket for firstly fixed to the ceiling, the bracket having a first lateral side and a second lateral side, the first lateral side having a first hole, the second lateral side having a second hole;
a LED module;
a driver circuit;
a panel with an output opening, light emitted from the LED module driven by a driving current of the driver circuit being output via the output opening to outside;
a surrounding wall connected with the panel;
a back cover fixed to the surrounding wall;
a first connector fixed to a first side the surrounding wall;
a second connector fixed to a second side of the surrounding wall,
wherein the panel, the surrounding wall, the back cover, the first connector and the second connector form a detachable panel module for being attached to the bracket, when the detachable panel module is attached to the bracket, the first connector and the second connector respectively have insertion portions kept in the first hole and the second hole to fix the detachable panel module to the bracket.

2. The panel light apparatus of claim 1, further comprising a third hole in the first lateral side and a fourth hole in the second lateral side of the bracket for connecting to a third connector and a fourth connector respectively fixed on the first side and the second side of the surrounding wall.

3. The panel light apparatus of claim 1, wherein the first connector and the second connector have rotation pins to be inserted into the first hole and the second hole by rotating the first connector and the second connector respectively.

4. The panel light apparatus of claim 1, wherein the first connector is directly inserted into the first hole and the second connector has a rotation pin to be inserted into the second hole by rotating the rotation pin of the second connector.

5. The panel light apparatus of claim 1, wherein the first connector has an elastic component for keeping the first connector in the first hole without an external force of a user, and for detaching the first connector away from the first hole when the user applies an external force against an elastic force of the elastic component.

6. The panel light apparatus of claim 5, wherein the elastic component is connected to an insertion pin disposed on a rotation shaft, the elastic component keeps the insertion pin in the first hole if no external force of a user is applied on the first connector, and the insertion pin is rotated by the user against the elastic force of the elastic component to escape the insertion pin out of the first hole to detach the detachable panel module from the bracket.

7. The panel light apparatus of claim 6, wherein the second connector also has a similar elastic component, a similar insertion pin and a similar rotation shaft.

8. The panel light apparatus of claim 1, further comprising a stop structure in the first hole to keep the first connector to stay in the first hole unless an external force applied to lift the detachable panel module to detach the first connector out of the first hole.

9. The panel light apparatus of claim 1, wherein the panel has a larger area than the bracket to cover the bracket.

10. The panel light apparatus of claim 1, wherein the bracket is a U shape structure, and the first lateral side and the second lateral side of the bracket are at least partly overlapping with the surrounding wall of the detachable panel module.

11. The panel light apparatus of claim 1, wherein the bracket further comprises a pluggable terminal for being electrically connected to the driver circuit.

12. The panel light apparatus of claim 1, wherein the first connector is electrically connected to the driver circuit and an electrical terminal in the first hole of the bracket.

13. The panel light apparatus of claim 1, wherein the back cover has a driver container space for storing the driver circuit inside the driver container space.

14. The panel light apparatus of claim 13, wherein the driver container space is defined by a convex part of the back cover, the back cover also has a concave part for pressing components below the back cover.

15. The panel light apparatus of claim 14, wherein a connection wire between the LED module and the driver circuit is routed inside the detachable panel module.

16. The panel light apparatus of claim 1, wherein a height of the surrounding wall is less than 5 cm.

17. The panel light apparatus of claim 1, wherein the panel is a polygonal shape.

18. The panel light apparatus of claim 1, wherein the panel is a circular shape.

19. The panel light apparatus of claim 1, wherein the LED modules are located on the surrounding wall and a light guide is used for guiding light of the LED module to the output opening.

20. The panel light apparatus of claim 1, wherein the back cover has a first aligning structure to fit to an associated a second aligning structure of the bracket for aligning the first connector to the first hole during installation.
